(19) United States
(12) Patent Application Publication
(10) Pub. No.: US 2025/0283815 A1
(43) Pub. Date: Sep. 11, 2025

(54) LABEL-FREE AUTOFLUORESCENCE-DETECTED MID-IR PHOTOTHERMAL MICROSCOPY

(71) Applicant: PURDUE RESEARCH FOUNDATION, West Lafayette, IN (US)

(72) Inventors: Garth J. SIMPSON, West Lafayette, IN (US); Minghe LI, West Lafayette, IN (US); Aleksandr RAZUMTCEV, West Lafayette, IN (US)

(21) Appl. No.: 18/859,948

(22) PCT Filed: May 1, 2023
(86) PCT No.: PCT/US2023/020591

§ 371 Date: Oct. 24, 2024

Related U.S. Application Data
(60) Provisional application No. 63/336,753, filed on Apr. 29, 2022.

(51) Int. Cl. G01N 21/64; G01N 21/3563

(52) U.S. Cl. CPC G01N 21/6402; G01N 21/3563; G01N 21/6458; G01N 2201/06113

(57) ABSTRACT

Label-free autofluorescence-detected photothermal mid-IR (AF-PTIR) microscopy is applied to test the distribution of materials within a sample. Two-photon excited UV-fluorescence (TPE-UVF) supports autofluorescence of native aromatic moieties using visible-light optics. Thermal modulation of the fluorescence quantum yield serves to report on infrared absorption, enabling infrared spectroscopy in the fingerprint region with a spatial resolution dictated by fluorescence. AF-PTIR provides high selectivity and sensitivity in image contrast for aromatic fluorescent materials, complementing broadly applicable optical photothermal IR (O-PTIR) microscopy based on photothermal modulation of refractive index/scattering. Mapping the fluorescent material distribution can be used to improve processes such as powdered dosage form manufacturing, with high spatial variance potentially producing variability in both delivered dosage and product efficacy. The ubiquity of aromatic moieties within active pharmaceutical ingredient candidates in particular suggests the viability of AF-PTIR in combination with O-PTIR to improve the confidence of chemical classification in spatially heterogeneous dosage forms.

### CROSS-REFERENCE TO RELATED APPLICATIONS

The instant application is being filed on 1 May 2023, as an International Application and claims the priority benefit of U.S. Provisional Patent Application Ser. No. 63/336,753, filed on 29 Apr. 2022, the contents of which are incorporated herein by reference in their entirety.

### BACKGROUND

Detection of infrared absorption in a sample can be used to determine material properties of that sample, including constituent materials and quantities thereof. The frequencies of infrared light, especially mid-infrared light (2.5-20 μm in wavelength) correspond to vibrational frequencies in molecular bonds. Thus, when a sample is illuminated by mid-IR light, it will absorb light at IR radiation frequencies corresponding to specific molecular vibration of chemical species in the sample. By measuring the absorption of IR light by a sample as a function of IR frequency (i.e., an IR absorption spectrum) the pattern of absorption peaks provides a “fingerprint” that can be used to characterize and/or identify chemical species in the sample.

Confocal fluorescence microscopy is a laser-based technique where radiation of one wavelength excites a fluorescent response in a sample that is detected at second wavelength or range of wavelengths. Extensive libraries of fluorescent dyes have been developed to target different functional and structural elements of biological materials, for example cells, tissues, and organisms. Fluorescence microscopy enables researchers and clinicians to create, visualize and analyze micrographs of a sample where each color represents the distribution of specific target structures within the biological material. Various fluorescence microscopy techniques are described, for example in Renz, “Fluorescence Microscopy—A historical and Technical Perspective,” Cytometry Part A, Vol 83, pp. 767-779 (2013) and Sanderson et al., “Fluorescence Microscopy,” Cold Spring Harb Protoc. 2014(10): pdb.top071795. doi:10.1101/pdb.top071795.

As an alternative to the use of fluorescent dyes, some materials can be detected based on their own inherent fluorescence (referred to herein as “autofluorescence”). Of particular interest are active materials, such as active pharmaceutical ingredients. Quantifying the spatial distribution of an active pharmaceutical ingredient (API) within the final dosage forms is an important step of drug product quality control. One of the main reasons for product recall of solid dosage forms is lack of content uniformity. The particle size and mixture ratio are among the crucial factors considered during the development of solid dosage forms, as they directly impact the bioavailability, dissolution rates and dosage unit content uniformity. Hence, identifying potential inhomogeneous distribution of the API particles is important for ensuring reproducible bioavailability within final dosage forms.

Many recently introduced microspectroscopy techniques rely on IR spectroscopy for chemical identification. Direct infrared microscopy in the fingerprint region uses far-field apertures to maximize the amount of IR radiation delivered to the focal plane for improved image quality. However due to the long wavelength of light, direct IR imaging in the fingerprint region is diffraction-limited at spatial resolution of 5-10 μm, which is insufficient for many applications.

Raman spectroscopy has the potential to address the resolution limits of direct IR absorption/scattering microscopy. Conventional Raman spectroscopy is complimentary to IR-based methods in accessing spectral information and it routinely achieves submicron resolution. However, spontaneous Raman measurements usually require long integration times due to weak Raman cross-sections of most analytes. More recently, coherent Raman spectroscopy, including stimulated Raman scattering (SRS) and coherent anti-Stokes Raman spectroscopy (CARS) have been shown to perform high speed, high resolution chemical microscopy. However, these methods require expensive instrumentation and are not cost-efficient for industrial use. Furthermore, relative to IR absorption, the shorter visible wavelengths associated with both spontaneous and stimulated Raman increase optical scatter and restrict analysis to a fairly narrow depth immediately adjacent to the interface.

### SUMMARY

According to an embodiment, a method for analyzing a sample includes illuminating a region of the sample with an infrared radiation beam, illuminating at least a sub-region of the region of the sample with a pulsed excitation beam having a shorter wavelength than the infrared radiation beam wherein the excitation beam is configured to excite multi-photon autofluoresence in the sample, collecting an autofluorescent emission from the sample in response to absorption of the pulsed excitation beam by the sample, detecting a change in the autofluorescent emission from the sample in response to absorption of infrared radiation by the sample, and generating measurements indicative of infrared absorption of the sub-region of the sample from the change in autofluorescent emission from the sample.

The method can further include producing a spectrum of infrared absorption of the sample. The radiation beam can be generated by an IR source comprising at least one quantum cascade laser. The infrared radiation beam can be generated by an array of quantum cascade lasers. The pulsed excitation beam can be generated by an ultrafast light source. The ultrafast light source can generate excitation pulses having a pulse duration of less than 200 femtoseconds. The ultrafast light source generates excitation pulses with a pulse duration of less than 10 nanoseconds. The ultrafast light source can emit visible radiation. The method can include constructing a spatially resolved image indicative of absorption of infrared radiation by the sample. The method can include constructing an image of symmetry-specific second harmonic generation. The method can include classifying individual particles within a pharmaceutical mixture. Classifying individual particles can include distinguishing excipient materials from active pharmaceutical ingredients, or distinguishing between different forms or polymophs of active pharmaceutical ingredients. The sample can be a pharmaceutical formulation. Collecting the autofluorescent emission can include detecting the autofluorescent emission from the sample at a detector that is either a photomultiplier tube or an avalanche photodiode.

According to a second embodiments, a photothermal infrared spectroscopy system can include an infrared source configured to illuminate a region of a sample with a beam of infrared radiation, an ultrafast light source configured illuminate a second region of the sample at least partially overlapping the infrared illuminated region, wherein the ultrafast light source is configured to excite multi-photon autofluorescence in the sample, at least one detector configured to detect autofluorescent emission from the sample, and a demodulator to detect a change in autofluorescent emission from the second region of the sample in response to absorption of infrared radiation by the second region of the sample.

The photothermal infrared spectroscopy system can further include a controller configured to produce measurements indicative of infrared absorption of the second region of the sample. The ultrafast light source can be a laser and a doubling crystal. The second focusing optic can be an objective having a numerical aperture of at least 0.60. The detector can be a photomultiplier tube or an avalanche photodiode.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram showing a counter-propagating two-photon excitation system according to an embodiment.

FIG. 2 shows a method for constructing an image of material characteristics using the system of FIG. 1.

FIG. 3 shows image data for a variety of materials taken using a system according to FIG. 1, including two-photon excited UV autofluorescence (TPE-UVF), second-harmonic generation (SHG), and bright field images.

FIGS. 4a, 4b, 4c, 4d, 4e, 4f, 4g, and 4h show bright field, SHG and TPE-UVF images for recovered modulation amplitudes demonstrating depth of modulation using the system of FIG. 1.

FIGS. 5a and 5d show spectra TPE-UVF photothermal spectra acquired by averaging across the bright regions in the field of view in FIGS. 5b, 5c, and 5e, 5f, respectively.

FIGS. 6a-6e show complementary measurements on a commercial

indomethacin final dosage form, depicting isolated particles having an observable size distribution, with both SHG and TPE-UVF observed from the sample.

FIGS. 7a, 7b, 7c, and 7d show pi-fluorescence field-of-view and corresponding UVF-PTIR images of tryptophan microcrystals are provided. In FIG. 7 panels C and D, epi-fluorescence field-of-view and corresponding UVF-PTIR images of lysozyme particles are provided.

FIGS. 8a, 8b, and 8c show simulated F-PTIR and O-PTIR time-dependent depth of modulation curves for 150 nm point source infrared absorption according to one embodiment.

### DETAILED DESCRIPTION

Optical Photothermal Infrared (OPTIR) spectroscopy is an emerging field that provides chemical analysis using infrared spectroscopy with a spatial resolution ten or more times finer than conventional Fourier Transform Infrared (FTIR) spectroscopy. OPTIR achieves higher spatial resolution than conventional IR spectroscopy by using a shorter wavelength “probe beam” to sense photothermal distortions in infrared absorbing regions of the sample. Various OPTIR techniques are described, for example, in U.S. Pat. Nos. 9,091,594, 9,841,324, and 10,677,722, 11,002,665, 10,942,116, and 10,809,184, each of which are incorporated herein by reference in their entireties.

Different materials can be detected and mapped within a sample to a high level of resolution using optical photothermal infrared spectroscopy as described in U.S. patent application Ser. No. 17/316,453 (published as US 2022/0065772 A1), the contents of which are incorporated herein by reference in their entirety.

### Definitions

For purposes of this specification, the following terms are specifically defined as follows:

An “analyzer/controller” refers to a system to facilitate data acquisition and control of an autofluorescent photothermal infrared (AF-PTIR) system. The analyzer/controller may be a single integrated electronic enclosure or may comprise multiple distributed elements. The control elements may provide control for positioning and/or scanning of the fiber probe and/or sample. They may also collect data about the probe beam deflection, motion or other response, provide control over the excitation and/or probe power, polarization, steering, focus and/or other functions. The control elements etc. may include a computer program method or a digital logic method and may be implemented using any combination of a variety of computing devices (computers, Personal Electronic Devices), analog and/or digital discrete circuit components (transistors, resistors, capacitors, inductors, diodes, etc.), programmable logic, microprocessors, microcontrollers, application-specific integrated circuits, or other circuit elements. A memory configured to store computer programs may be implemented along with discrete circuit components to carry out one or more of the processes described herein.

“Beam combiner” means an optical element that can combine two beams onto the same optical path. A dichroic mirror or filter for example can be used as a beam combiner where the dichroic can be configured to transmit one or more wavelength range and reflect one or more other wavelength ranges. Two beams arranged for example at right angles incident on the dichroic can then combine two beams onto the same path. In one configuration, a beam combiner may be a beam splitter used in a reverse direction, i.e., combining one beam that reflects off the beam splitter interface with another beam that is transmitted through the beam splitter interface. A beam splitter cube, for example, can be used as both a beam splitter and a beam combiner. Optical elements that are marketed as beam splitters can be used as a beam combiner, even if they are not used to split light onto two paths. For example, a Mach-Zehnder interferometer uses one beam splitter to split incident light onto two paths and a second beam splitter to recombine the two beams. In this case, the second beam splitter is being used as a beam combiner. In a Michelson interferometer, a single beam splitter is used to both divide the incident light and then recombine it. Thus, the beam splitter in a Michelson interferometer as being used as both a beam splitter and a beam combiner. A beam combiner can also be an optical fiber-based device, for example combining the light from two input fibers into one output fiber, for example a 1×2 fiber coupler. A single 1×2 fiber coupler can be used as both a beam splitter and a beam combiner.

“Beam splitter” refers to an optical element that can divide light onto at least two paths. A beam splitter can comprise a plate, a cube and/or a prism or other shapes/configurations that can divide a beam of light. The beam splitter can comprise a thin film that is partially reflecting at the wavelength of interest such that a portion of an incident beam is reflected and another portion is transmitted. A beam splitter may be polarizing, wherein in substantially transmits light of one polarization and reflects light of an orthogonal polarization. A beam splitter may also divide light along two transmission paths based on polarization, for example in the case that the beam splitter is a Nomarski or Wollaston prism. A beam splitter may also be non-polarizing, where light is divided between two paths without substantial dependence on the polarization of the incident light. A beam splitter can also be an optical fiber-based device, for example splitting light from one input optical fiber into at least two output optical fibers, for example a 1×2 fiber coupler. A beam splitter may be a 50:50 beam splitter in which substantially equal fractions of light are directed on two different paths. They can also be unbalanced, for example a 90:10 or 70:30 or similar beam splitter that direction 90% of light on one path and 10% on another, or 70% on one path and 30% on another.

“Bleaching” refers to photobleaching, or the tendency of a sample to have decreasing fluorescent response to optical stimulation with increasing duration of exposure. Samples, and in particular those with fluorescent response, can be damaged by exposure to light, especially at the excitation wavelengths that cause an autofluorescent response.

“Collecting probe light” and “collecting probe radiation” refer to collecting radiation of a probe light beam that has interacted with a sample. The probe light can be collected after reflection, scattering, transmission, evanescent wave coupling, and/or transmission through an aperture probe.

“Collimating optic” refers to any of the above optical elements arranged in a way to generally collimate radiation. In some embodiments the same optic(s) may serve as both a focusing optic and a collimating optic, for example focusing light in one direction of propagation and then recollimating the light in the opposite direction of propagation.

“Confocal microscopy” refers to a form of optical microscopy in which the light collected at a detector is confined to light that passes through a small volume within the 3D focus volume of an optical objective on a sample. Confocal microscopy is often performed by placing a “confocal aperture” at a focal plane that is equivalent with the focal plane of the sample, thus blocking stray light that does not pass through the focus volume on the sample.

A “detector” refers to a device that produces a signal indicative of the power, intensity and/or energy of light/radiation incident on the detector surface. The signal will generally be an electrical signal, for example a voltage, current and/or an electrical charge. The detector may be a photodiode, a phototransistor, a charge coupled device (CCD). In some cases, a detector may be a semiconducting detector, for example a silicon PIN photodiode. A detector may also be an avalanche photodiode, a photomultiplier tube, or any other device that produce a change in current, voltage, charge, conductivity or similar upon incidence of light. A detector may comprise a single element, multiple detector elements, for example a bi-cell or quad-cell, a linear or two-dimensional array of detector elements, including camera-based detectors. An “array-based detector” means a detector that can comprise multiple photosensitive elements, for example a linear array or 2D array of photosensitive elements, and/or a 1D or 2D array of photosensitive pixels. An array-based detector can be an optical detector comprising an array with a plurality of photosensitive elements, for example a linear array or 2D array of photodiodes, or a linear or 2D array of photosensitive pixels, for example in camera-based detectors. An array-based detector can be analog devices like a photodiode array and/or hybrid analog/digital devices like camera-based detectors. A “camera” or “camera-based detector” refers to a type of array-based photodetector comprising a plurality of photosensitive pixels. A camera may comprise one or more technology including but not limited to CCD, EM-CCD, CMOS, s-CMOS, and/or other photosensitive array technologies. The camera may support frame rates from a few frames per seconds, hundreds of frames per second, or even thousands of frames per second or higher.

“Diffraction limit” of a light beam means the minimum separation of two optical sources that can be distinguished by a detector. The Abbe diffraction limit d for a microscope having a numerical aperture NA and operating at a wavelength λ is defined as d=λ/(2 NA). Physical restraints on the numerical aperture of a microscope prohibit very large numerical apertures, and therefore the diffraction limit of a microscope depends strongly upon the operating wavelength used for detection, with large wavelengths corresponding to relatively poor resolution and high wavelengths corresponding to increased precision.

“Demodulate” or “demodulation” refers to extracting an information-bearing signal from an overall signal, usually, but not necessarily at a specific frequency. For example, in this application, the collected probe light collected at a photo detector represents an overall signal. The demodulation process picks out the portion that is being perturbed by infrared light absorbed by the sample. Demodulation can be accomplished by a lock-in amplifier, a fast Fourier transform (FFT), a calculation of a discrete Fourier component at a desired frequency, a resonant amplifier, a narrow band bandpass filter, or any other technique that largely enhances the signal of interest while suppressing background and noise signals that are not in sync with the modulation. A demodulator may produce any of a series of signals including an amplitude and/or phase of modulation of the information bearing signal, and/or in-phase (X) or quadrature (Y) signals or any other desired signal indicative of a property of a change in the information-bearing signal.

A “demodulator” refers to a device or system that performs demodulation.

“Figure of merit” refers to any metric or indicator of the relative quality of a signal or measurement. The figure of merit can for example be a measurement sensitivity, a signal strength, a noise level, a signal to noise ratio, a background level, a signal to background ratio, any combination of these, or other metric that lets one rank the relative quality of a signal and/or measurement.

“Focusing optic” refers to one or more optical elements with the ability to focus light. A focusing optic can comprise one or more refractive lenses, curved mirrors, diffractive optics, Fresnel lenses, volume hologram, metamaterial, or any combination thereof or any other device or component capable of focusing radiation.

“Fluorescence” refers to the emission of light from a sample at one wavelength due to excitation at another wavelength. Fluorescent excitation and emission processes are a form of inelastic scattering of incident light and can be used to characterize a sample by providing information about the types of fluorescent emissions (number of photons emitted, and wavelength of emitted photons) based on a particular intensity and spectrum of incident light. “Autofluorescence” refers to fluorescence that occurs naturally upon exposure of a sample to an excitation source, while fluorescence more broadly can refer either to autofluorescence or to exogenous fluorescence via the application/integration of external fluorophores like fluorescent dyes, fluorescent proteins, and fluorescent nanoparticles or other fluorescence treatments.

“Illuminate,” “illuminating,” and “illumination” mean to direct radiation at an object, for example a surface of a sample, the probe tip, and/or the region of probe-sample interaction. Illumination may include radiation in the infrared wavelength range, visible, and other wavelengths from ultraviolet to a millimeter or more. Illumination may include any arbitrary configuration of radiation sources, reflecting elements, focusing elements and any other beam steering or conditioning elements.

“Infrared absorption spectrum” refers to a spectrum that is indicative of the wavelength dependence of the infrared absorption coefficient, absorbance, or similar indication of IR absorption properties of a sample. An example of an infrared absorption spectrum is the absorption measurement produced by a Fourier Transform Infrared spectrometer (FTIR), i.e. an FTIR absorption spectrum. In general, infrared light will either be absorbed (i.e., a part of the infrared absorption spectrum), transmitted (i.e., a part of the infrared transmission spectrum), or reflected. Reflected or transmitted spectra of a collected probe light can have a different intensity at each wavelength as compared to the intensity at that wavelength in the probe light source. It is noted that IR measurements are often plotted showing the amount of transmitted light as an alternative to showing the amount of light absorbed. For the purposes of this definition, IR transmission spectra and IR absorption spectra are considered equivalent as the two data sets as there is a simple relationship between the two measurements.

“Infrared source” and “source of infrared radiation” refer to one or more optical sources that generates or emits radiation in the infrared wavelength range, generally between 2-25 microns. The radiation source may be one of a large number of sources, including thermal or Globar sources, supercontinuum laser sources, frequency combs, difference frequency generators, sum frequency generators, harmonic generators, optical parametric oscillators (OPOs), optical parametric generators (OPGs), quantum cascade lasers (QCLs), interband cavity lasers (ICLs), synchrotron infrared radiation sources, nanosecond, picosecond, femtosecond and attosecond laser systems, C02 lasers, microscopic heaters, electrically or chemically generated sparks, laser driven thermal light sources, and/or any other source that produces emission of infrared radiation. The source emits infrared radiation in a preferred embodiment, but it can also emit in other wavelength ranges, for example from ultraviolet to THz. The source may be narrowband, for example with a spectral width of <10 cm 1 or <1 cm 1 less, or may be broadband, for example with a spectral width of >10 cm 1, >100 cm 1 or greater than 500 cm 1. Broadband sources can be made narrow band with filters, monochromators and other devices. The infrared source can also be made up of one of discrete emission lines, e.g. tuned to specific absorption bands of target species. IR sources with narrower wavelength can be coupled together to produce an IR source with a wider wavelength range, for example a QCL and an OPO, or multiple external cavity QCL modules, or even a large array of QCL emitters.

“Interacting” in the context of interacting with a sample means that light illuminating a sample is at least one of scattered, refracted, absorbed, aberrated, diverted, diffracted, transmitted, and reflected by, through and/or from the sample.

A “lock-in amplifier” is one example of a “demodulator” (defined above) and is a device, system, and/or an algorithm that demodulates the response of a system at one of more reference frequencies. Lock-in amplifiers may be electronic assemblies that comprise analog electronics, digital electronics, and combinations of the two. They may also be computational algorithms implemented on digital electronic devices like microprocessors, field programmable gate arrays (FPGAs), digital signal processors, and personal computers. A lock-in amplifier can produce signals indicative of various metrics of an oscillatory system, including amplitude, phase, in phase (X) and quadrature (Y) components or any combination of the above. The lock-in amplifier in this context can also produce such measurements at both the reference frequencies, higher harmonics of the reference frequencies, and/or sideband frequencies of the reference frequencies.

“Modulating” or “modulation” when referring to radiation incident on a sample refers to changing the infrared laser intensity at a location periodically. Modulating the light beam intensity can be achieved by means of mechanical chopping of the beam, controlled laser pulsing, and/or deflecting the laser beam, for example by a tilting mirror that is driven electrostatically, electromagnetically, with piezo actuators or other means to tilt or deform the mirror, or high-speed rotating mirror devices. Modulation can also be accomplished with devices that provide time varying transmission like acousto-optic modulators, electro-optic modulators, photo-elastic modulators, pockel cells, and the like, and more generally any electronically controllable device that can change the amplitude and/or optical phase of an incident light beam. Modulation can also be accomplished with diffraction effects, for example by diffractive MEMS-based modulators, or by high-speed shutters, attenuators, or other mechanisms that change the intensity, angle, and/or phase of the laser intensity incident on the sample. The modulation can for example comprise any form of periodic waveform, for example sinusoidal waves, square waves, pulses, triangle waves, chirps, etc. The modulation may be performed at a single modulation frequency or may be a composite of any number of desired frequency components. In some cases the modulation can also be aperiodic or comprise only single pulses. A “modulated source of radiation” is a source of radiation that comprises in some fashion the ability to modulate the optical power it delivers. A modulated source of radiation can be a source with the internal ability to pulse and/or modulate its power, a radiation source with an external trigger/modulation control, and/or a CW radiation source coupled with an external modulator, for example a mechanical chopper, an acousto-optical modulator or any of the other modulators described above or any other suitable mechanism for varying the power delivered by the radiation source. Note that in a modulated source of radiation, the radiation source and the modulator may be physically decoupled and there may be other optical elements like lenses, mirrors, filters, etc. between the radiation source and the modulator.

“Near infrared light” generally refers to a wavelength range of infrared (IR) light corresponding to 0.75-2 μm.

A “narrowband light source” a light source with a narrow bandwidth or linewidth, for example a light of linewidth smaller than 8 cm−1, but in general it can be a light source with a linewidth narrow enough that the linewidth does not cover a spectral range of interest of the sample.

“Optical property” refers to an optical property of a sample, including but not limited to index of refraction, absorption coefficient, reflectivity, absorptivity, real and/or imaginary components of the index refraction, real and/or imaginary components of the sample dielectric function and/or any property that is mathematically derivable from one or more of these optical properties.

“Optical response” refers to the result of interaction of radiation with a sample. The optical response is related to one or more optical properties defined above. The optical response can be an absorption of radiation, a temperature increase, a thermal expansion, a photo-induced force, the reflection and/or scattering of light or other response of a material due to the interaction with illuminating radiation.

“Photothermal distortion” refers to a change in the properties of a sample due to absorption of optical energy, for example the absorption of IR radiation. The photothermal distortion may refer to a change in index of refraction, reflectivity, thermal expansion, surface distortion, or other effects that can be detected with a probe beam.

An “excitation source,” “excitation light source,” or “excitation radiation source” refers to a light source that can be used for causing a sample to fluoresce. Such light sources can be used to probe the response of the sample to the incidence of light from the infrared light source. The excitation source may comprise a gas laser, a laser diode, a diode pumped solid state laser, a supercontinuum laser, an optical parametric oscillator, a superluminescent diode (SLD), a near infrared laser, a UV and/or visible laser beam generated via sum frequency or difference frequency generation, for example. In some embodiments, the probe light source may operate at a wavelength that is outside the tuning or emission range of the infrared light source, but the probe light source can also be a fixed wavelength source at a select wavelength that does in fact overlap with the tuning range of the infrared light source. A “probe light beam” or “sensing light beam” is a beam originally emitted from a probe light source. An “autofluorescence excitation source,” “autofluorescence excitation light source,” or “autofluorescence excitation radiation source” is an excitation source configured to excite autofluorescent emission from the sample.

A “retarder” refers to an optical element that induces a relative optical phase delay in an optical path. Examples of retarders are wave plates, for example half wave plates, quarter wave plates and eight wave plates. One or more retarders/wave plates can be used to introduce an optical phase difference between two polarizations of light, for example to introduce a phase difference between two paths of a quadrature interferometer.

“Signal indicative of’ refers to a signal that is mathematically related to a property of interest. The signal may be an analog signal, a digital signal, and/or one or more numbers stored in a computer or other digital electronic device. The signal may be a voltage, a current, or any other signal that may be readily transduced and recorded. The signal may be mathematically identical to the property being measured, for example explicitly an absolute phase signal or an absorption coefficient. It may also be a signal that is mathematically related to one or more properties of interest, for example including linear or other scaling, offsets, inversion, or even complex mathematical manipulations.

“Spectrum” refers to a measurement of one or more properties of a sample as a function of wavelength or equivalently (and more commonly) as a function of wavenumber.

“Ultrafast light sources,” such as ultrafast lasers, refers to light sources with pulse durations on the order of attoseconds to nanoseconds.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

### Two-Photon Excitation

In traditional fluorescence microscopy, samples are often labeled with fluorescent dyes or fluorescent proteins that are then excited with an excitation source causing emission at a shifted wavelength. Some samples have autofluorescent properties which will emit wavelength shifted radiation without fluorescent labeling. Many such samples are especially sensitive to autofluorescent excitation at ultraviolet wavelengths. An alternative approach is two-photon UV autofluorescence which involves simultaneously exciting the sample with two visible wavelength photons to provoke a second order optical response where electrons in the sample gain energy corresponding to twice the single photon energy, i.e. equivalent to the energy in a UV photon. The sample can then emit radiation as if excited by UV photons, including wavelength shifted autofluorescent emission at longer wavelengths which is then detected by a photodetector. Because two photon UV autofluorescence is a second order effect, a high peak-power laser is generally used to provide sufficient flux to produce nonlinear optical effects. Suitable ultrafast light sources, such as high-intensity pulsed lasers for two photon excitation, are typically femtosecond lasers with pulse durations in the range of 10-300 fs which results in high peak power sufficient to induce nonlinear optical effects like two photon fluorescence. But longer pulse durations, e.g. picosecond or even nanosecond would work with high enough laser energy. Femtosecond lasers are often preferred because they provide high peak power but low enough average power to prevent sample damage.

Two-photon excitation can provide several advantages over traditional fluorescence microscopy, including better spatial resolution and less photodamage to the sample.

### Pharmaceutical Considerations

Analytical tools capable of rapidly and accurately informing on the quantitative distribution of solid-state composition within final dosage forms are critical for control uniformity in dosage form manufacturing of active pharmaceutical ingredients (API) as described above.

The ubiquitous presence of native autofluorescence in the UV region for most proteins and many active pharmaceutical ingredients raises the interesting possibility of integrating F-PTIR with autofluorescence for label-free analysis. The use of UV absorption (and to a lesser extent, fluorescence) is well established for selective detection of proteins, finding wide-spread use in chromatography. Similarly, aromatic amino acids are ubiquitous within therapeutic proteins. For API analysis, previous studies by Toth et al. have reported two-photon excited UV autofluorescence (TPE-UVF) from numerous active pharmaceutical ingredients. Unlike direct UV-b absorption, multiphoton excitation with ultrafast visible light sources offers several practical advantages, including compatibility with conventional glass optics and intrinsic optical sectioning within turbid media, such as powders and compacts.

Fluorescence-based methods have been explored previously for pharmaceutical materials analysis, leveraging the ubiquitous incorporation of aromatic moieties within many small molecule APIs. Chen et al. has developed a UV-fluorescence based instrument for determination of amiloride (AMI) in pharmaceutical tablet and human serum. Toth and coworkers compared UV-SHG with TPE-UVF for API detection, demonstrating reasonably high selectivity for APIs by TPE-UVF. However, use of fluorescence as a standalone method can be problematic from a measurement science perspective. Most notably, many common excipients exhibit native TPE-UVF signals (e.g., TiO2 and HPMC), reducing the selectivity for the API. Furthermore, minute quantities of trace impurities following synthesis may potentially contribute to background UV autofluorescence in poorly controlled manners. Other unexpected sources of TPE-UVF background may also potential interfere with selective detection of the API, such as surface defects, amine-oxygen exciplex formation, and proteinaceous airborne particulates. Spectroscopically, emission spectra of these different fluorescence sources tend to be broad and highly overlapping in the UV, complicating reliable spectral decomposition. Short fluorescence lifetimes common in the UV region also tend to minimize the potential benefits of lifetime imaging. Consequently, there are advantages to utilizing spectral signals more directly dependent on molecular and macromolecular structure, while still seeking to leverage the preferential contrast of intrinsic autofluorescence.

An alternative detection scheme based on measuring temperature-induced changes in fluorescence quantum efficiency has been recently developed. Fluorescence-detected photothermal mid-IR (F-PTIR) microscopy was shown to achieve at least an order of magnitude signal to noise improvement over conventional O-PTIR and was applied for living cell imaging and characterization of phase separated microdomains in pharmaceutical amorphous solid dispersions. Notably, the use of fluorescence enabled analysis of vibrational spectroscopy immediately adjacent to fluorescent regions of interest (e.g., targeted by selective chemical labeling with fluorophores). This suppression of background interference from nonfluorescent regions can greatly improve sensitivity and selectivity. However, in some instances the addition of a fluorescent reporter also has the potential to limit the breadth of applications for F-PTIR microscopy and might introduce perturbations to the studied system.

Fluorescence-based methods have been explored previously for pharmaceutical materials analysis, leveraging the ubiquitous incorporation of aromatic moieties within many small molecule APIs, such as a UV-fluorescence based instrument for determination of amiloride (AMI) in pharmaceutical tablet and human serum. Chen, W.; Xiong, Y.; Wang, W.; Wu, T.; Li, L.; Kang, Q.; Du, Y. Assembly of a UV-LED Induced Fluorescence System for Rapid Determination of Amiloride in Pharmaceutical Tablet and Human Serum. Talanta 2019, 203, 77-82 (https://doi.org/https://doi.org/10.1016/j.talanta.2019.05.010).

Toth and coworkers compared UV-SHG with TPE-UVF for API detection, demonstrating reasonably high selectivity for APIs by TPE-UVF. However, use of fluorescence as a standalone method can be problematic from a measurement science perspective. Most notably, many common excipients exhibit native TPE-UVF signals (e.g., TiO2 and HPMC), reducing the selectivity for the API. Furthermore, minute quantities of trace impurities following synthesis may potentially contribute to background UV autofluorescence in poorly controlled manners. Other unexpected sources of TPE-UVF background may also potential interfere with selective detection of the API, such as surface defects, amine-oxygen exciplex formation, proteinaceous airborne particulates. Spectroscopically, emission spectra of these different fluorescence sources tend to be broad and highly overlapping in the UV, complicating reliable spectral decomposition. Short fluorescence lifetimes common in the UV region also tend to minimize the potential benefits of lifetime imaging. Consequently, there are advantages to utilizing spectral signals more directly dependent on molecular and macromolecular structure, while still seeking to leverage the preferential contrast of intrinsic autofluorescence.

In this work, autofluorescence-detected photothermal infrared (AF-PTIR) spectroscopy is demonstrated experimentally and applied to recover fingerprint region spectra of individual API (indomethacin) particles with high selectivity in powdered mixtures of common excipients. The AF-PTIR microscope system supports multimodal nonlinear microscopy combining mid-IR microspectroscopy with symmetry-specific second harmonic generation (SHG) imaging and two-photon excited UV-fluorescence microscopy (TPE-UVF). Multi-modal imaging in combination with AF-PTIR enabled chemical classification of individual particulates within mixtures designed to be representative of final dosage forms.

It should be understood that while APIs are a particular promising implementation, other materials and sample types could be characterized using the systems and techniques described herein. Pharmaceutical uses are just one area in which identification of autofluorescence is useful. In general, the two-photon excitation approach in combination with infrared detection on the active or fluorescent material therein provides insights into material characteristics that are not available using conventional techniques.

Reference will now be made in detail to exemplary aspects of the present disclosure that are illustrated in the accompanying drawings. Wherever possible, the same reference numbers will be used throughout the drawings to refer to the same or like parts.

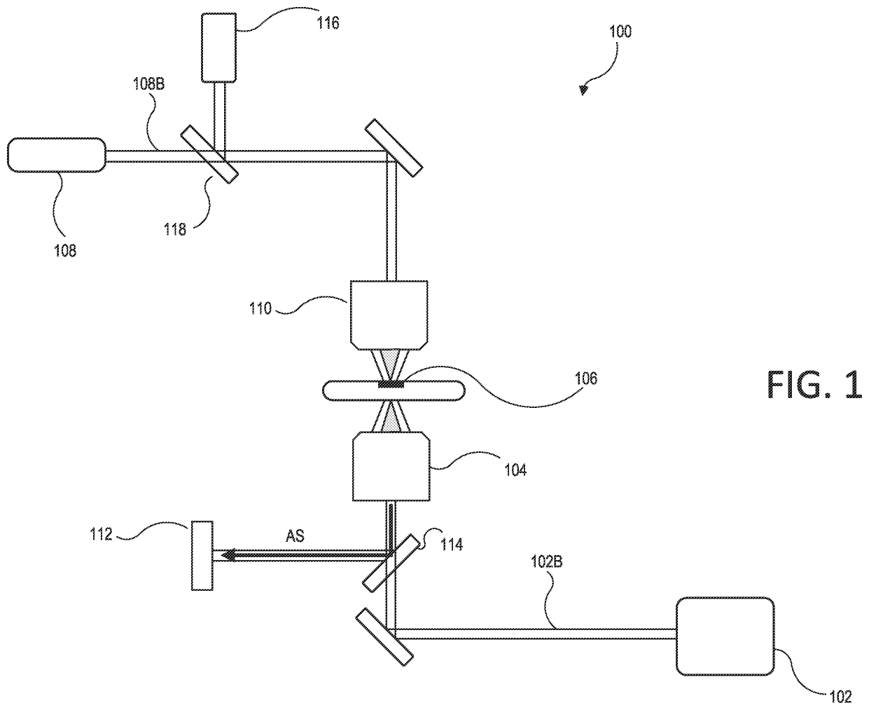

FIG. 1 depicts an autofluorescence-detected photothermal spectroscopy system 100 that implements two-photon detection. System 100 includes an ultrafast excitation beam source 102 generating an excitation beam 102B. Probe beam 102B can be at a visible wavelength, such as at 532 nm, which is useful for creating two-photon initiated fluorescence in a wide variety of active materials. In one embodiment, the excitation beam 102B is generated by a 50 MHz 1064 nm femtosecond laser such as a Fianium FemtoPower laser with 185 fs pulse duration at 1 W power, which can be frequency-doubled to produce an ultrafast 532 nm beam for laser transmittance imaging and two-photon excitation.

The excitation beam 102B can be directed via any number of mirrors or other optical components (not individually labeled with reference numbers in FIG. 1), before arriving at first focusing optic 104. First focusing optic 104 focuses the excitation beam 102B from ultrafast excitation beam source 102 to a sample 106. In one embodiment, the first focusing optic 104 can be a 40×0.60 NA Nikon Plan Fluor ELWD objective, though in alternative embodiments it should be understood any other focusing optic appropriate for use with the wavelength of the excitation beam 102B could be used. For example objectives with NA in the range 0.8-0.95 can be used for samples in air and even higher NAs (e.g. >1) can be achieved with immersion objectives.

IR beam source 108 similarly creates IR beam 108B that illuminates the sample 106. In one embodiment, IR beam source 108 can be a mid-IR array of independent quantum cascade lasers (QCL) covering the spectral range between 1054 cm−1 and 1186 cm−1 producing 300 ns pulses at a 33 kHz repetition rate to create “hot frames” (in which the sample is heated by the IR beam 108B) and “cold frames (in which the sample is not heated by the IR beam 108B). The duty cycle within the burst period can be maintained at about 1%, in one embodiment. An external function generator can be used to trigger the IR beam source 108, such as an 80 MHz function generator used to externally trigger a set of QCLs. Other implementations can include the use of choppers or other physical or electronic modulation devices and techniques.

As with the excitation beam source 102, IR beam source 108 can be used to illuminate the sample after interacting with other optical components, ending at second focusing optic 110 that focuses the IR beam 108B onto a portion or region of the sample 106 that overlaps with the portion or region illuminated with the excitation beam 102B. In one embodiment, the second focusing optic 110 is an aspheric ZnSe objective having a numerical aperture of 1.0. In practice a wide range of numerical apertures can be used, depending on the power of the IR source, the desired working distance and other factors. Note that other IR focusing elements can be employed instead, for example other refractive lenses made for example of other infrared transparent materials like calcium fluoride or barium fluoride, or alternately a reflective objective, e.g. a Schwarzschild objective or similar design, and/or an off axis parabolic mirror or any other optical element or collection of elements capable of focusing infrared light. In some cases with a high intensity IR source, it may not be necessary to focus the IR source.

Autofluorescent emission (indicated with the arrow labeled “AS” in FIG. 1) is collected by one or more collecting optics. In the configuration shown in FIG. 1, autofluorescent emission is collected by focusing optic 104 in a so-called “epi” configuration, i.e. collecting backscattered fluorescent emission. Autofluorescent emission could also be collected on the other side of the sample for example by focusing optic 110. In the configuration shown, collected autofluorescent light is reflected by dichroic mirror 114 to detector 112. Other filters such a notch filter and shortpass filters (not shown) can be used to suppress the excitation light that would otherwise be directed to the detector 112. Detector 112 can be, for example, a photomultiplier tube, or other sensitive detector like an avalanche photodiode.

To collect the SHG signal, a visible blocking filter was installed after the doubling crystal to suppress the doubled frequency and pass the fundamental 1064 nm light. The polarization state of the attenuated beam was adjusted with a waveplate to suppress SHG within the doubling crystal. The SHG signal from the sample plane was collected with the same PMT used for UV-fluorescence measurements after replacing the dichroic mirror (570 nm longpass) and PMT filter set (Thorlabs KG3 filter and Edmund Optics 53015 nm bandpass filter). The wavelengths to be filtered and transmitted depend upon the type of fluorescence to be detected.

In one example, two-photon excitation and fluorescence occurs when two 532-nm photons are absorbed and a 350 nm photon is fluoresced. In that embodiment, the dichroic mirror 114 can be reflective to light in the range of 350 nm, while being transmissive to light in the range of 532 nm. In embodiments where a frequency-doubling crystal or other optical component that affects the wavelength of the excitation beam 102B is used, appropriate modifications to the transmissive and reflective wavelength ranges can be made based upon the wavelength of the beam at the point where it passes through the dichroic mirror 114.

Optionally, the system 100 of FIG. 1 can include brightfield imaging capabilities. As shown in FIG. 1, the transmitted excitation beam 102B (which is in the visible wavelength range) can be collected with a photodiode 116, such as Thorlabs DET10A. Use of an appropriate dichroic mirror 118 can direct most light in the visible wavelength range (e.g., 532 nm) towards the photodiode 116, while transmitting IR wavelengths corresponding to the IR beam 108B. In various embodiments, other types of detectors could be used in lieu of photodiode 116, or the brightfield detection system can be suitable for direct viewing by a user.

As shown in FIG. 1, sample 106 is held at a position along the beampath that is in between the excitation source 102 and the IR beam source 108, such that excitation beam 102B interacts with sample 106 at one side and IR beam 108B interacts with the sample 106 at the opposite side. This so-called counter-propagating arrangement could be modified in alternative embodiments, which can include co-propagating arrangements in which both the IR beam 108B and the excitation beam 102B interact with the same side of the sample 106. Additionally, samples 106 can be mounted on a movable stage, such as a piezoelectric stage, to be moved relative to the incoming beams 102B and 108B.

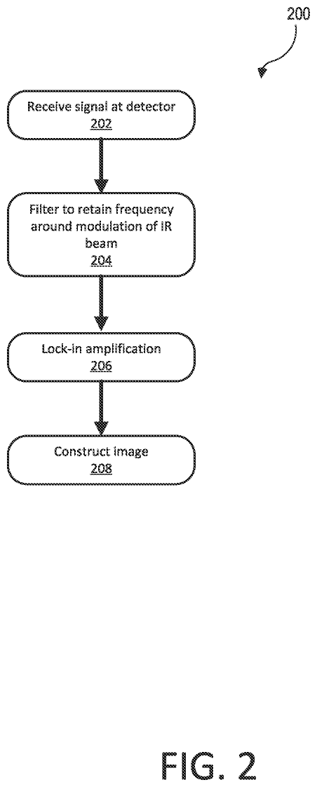

FIG. 2 shows a method for processing signal from the system 100 of FIG. 1.

As 202, signal is received at detector 112. For AF-PTIR imaging, the signal from detector 112 can be frequency filtered at 204 to retain the frequency components in a narrow window around the modulation frequency of the IR beam 108B. This filtered signal at 204 can optionally be digitized. The digitizer can be externally clocked by the same function generator used to modulate the trigger signal for the IR source 108.

At 206, lock-in amplification can be performed by fitting the resulting waveforms to a sine function to recover amplitude and phase relative to the IR source 108 trigger or other modulation signal or frequency. The calculated amplitude on each pixel of the detector 112 can used as the AF-PTIR signal intensity to construct the image of the sample 106 at 208.

In one example, the total image acquisition time was 75 s for 50×50 pixels AF-PTIR images and 300 s for a higher-resolution 100×100 pixels images with a 30 ms pixel dwell time in both cases.

For two-photon excited UV-fluorescence, Second Harmonic Generation (SHG), and bright field imaging, the preamplified detected signal can be lowpass filtered to remove high frequency components, and then digitized, similar to the method described in FIG. 2. The acquisition time was 20 s to produce 200×200 pixels images with a 500 s pixel dwell time.

Optically-detected photothermal mid-IR microscopy can also be conducted on the AF-PTIR system 100 in a back-scattered configuration. The dichroic mirror 114 can be replaced with a glass slide at 45° to reflect a fraction of the back-scattered incident light. A 530-nm bandpass filter can be positioned in front of the detector 112. The data analysis method is then analogous to the one described above with respect to FIG. 2.

### Pharmaceutical Examples

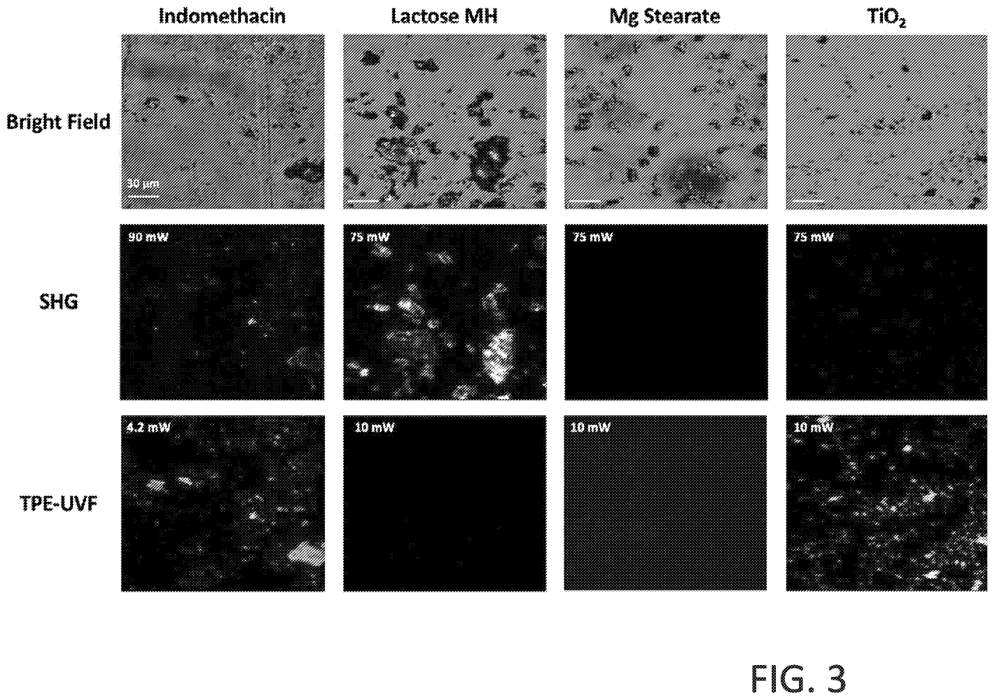

FIG. 3 depicts the brightfield, Second Harmonic Generation (SHG), and Two-photon excited UV-fluorescence (TPE-UVF) images generated using a set of pharmaceutical materials: Indomethacin, Lactose monohydrate (MH), Magnesium Stearate, and Titanium dioxide (TiO₂). Each of the pharmaceutical materials was imaged as a powder. Lactose MH and indomethacin particles were filtered by size between 25 um and 125 μm sieves and then physically mixed with other components in a 1:1:1:1 mass ratio to produce a tablet-like mixture. Powdered samples were prepared on mid-IR transparent amorphous calcium fluoride microscope slide substrates. All images collected with one method are presented at the same brightness scale. Bright field was collected by measuring the transmitted light. SHG and TPE-UVF were collected in an epi-configuration with incident wavelengths of 532 nm and 1064 nm, respectively. by switching the filter sets in front of the detector. Incident radiation power was measured right before the sample plane.

Powder X-ray diffraction (PXRD) patterns of indomethacin were acquired by using a Panalytical Empyrean Powder X-ray diffractometer with Cu K irradiation at room temperature. The measurements were conducted using a reflection/transmission spinner. Rietveld refinement was conducted for fitting the experimental data.

Label-free AF-PTIR microscopy was applied to acquire a mid-IR absorption spectrum of indomethacin crystals. Indomethacin is a small-molecule anti-inflammatory drug containing aromatic conjugation in its structure and, therefore, has potential to exhibit substantial TPE-UVF activity. Consistent with these expectations, a strong TPE-UVF response was observed from indomethacin microcrystals. A spatial resolution for TPE-UVF image was calculated to be 0.79 μm by edge derivative analysis, which is slightly less than the 0.54 m theoretical maximum predicted for Gaussian optics.

The mid-IR spectrum of indomethacin in the fingerprint region was recovered by measuring the AF-PTIR intensity when cycling through each of a series of individual QCL channels that make up the IR source 108 in one embodiment.

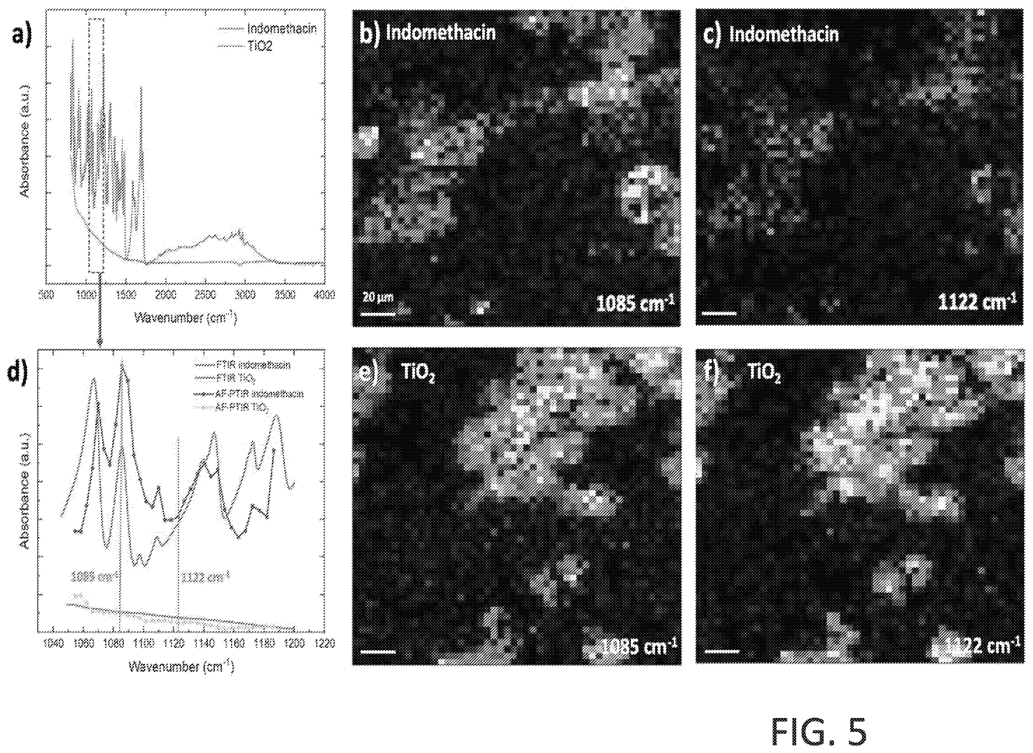

The TPE-UVF photothermal spectrum shown in FIG. 5d was acquired by averaging across the bright regions in the field of view. The spectrum agrees well with ATR-FTIR spectra of pure indomethacin powders. The notable deviation of the peak around 1060 cm−1 from its center position in FTIR spectrum is tentatively attributed to differences in signal to noise in the spectral measurements. The lowest energy spectral channels also exhibited the lowest power outputs, which correlated with greater disparities between the FTIR and F-PTIR spectra.

The relative intensity of the AF-PTIR signal for on- and off-resonance cases is compared in FIG. 5 (b and c), indicating correlations between AF-PTIR brightness and mid-IR absorption.

The AF-PTIR signal intensity at the same spectral channels was also compared for titanium dioxide powder. TiO2 is a common pharmaceutical excipient exhibiting substantial TPE-UVF activity. AF-PTIR images of pure TiO2 powder were collected for the same two channels as used for indomethacin, shown in FIG. 5 (e and f). No substantial difference in AF-PTIR intensity was observed for these two spectral channels for TiO2, in contrast to the indomethacin response.

### Nonlinear Optical Microscopy of Indomethacin and Pharmaceutical Excipients

Complementary measurements were performed on pure materials and on prepared mixtures of materials designed to reflect the contents of commercially available final dosage forms of indomethacin. Indomethacin capsules contain a mixture of indomethacin, a-lactose monohydrate, sodium lauryl sulfate, sodium starch glycolate, magnesium stearate, titanium dioxide and colloidal silicon dioxide encapsulated within a hard shell made of gelatin and coloring agents. Four materials were investigated to represent the major classes of materials used, including the API itself, lactose monohydrate (often added for tableting), magnesium stearate as a representative surfactant, and TiO2 as a representative inorganic constituent (often added to tablets as a pigment or to minimize UV exposure). Bright field, SHG, and TPE-UVF images of these four isolated representative materials are shown in FIG. 3.

The observations for the pure components shown in FIG. 3 are in good agreement with both chemical intuition and prior published work. Pure indomethacin showed the strongest TPE-UVF activity among the tested compounds. However, titania microparticles produced a similarly bright image under slightly over than twice of the laser power used to image the API crystals. Lactose crystals showed the strongest SHG activity consistent with the noncentrosymmetry inherent in the lactose MH lattice. Magnesium stearate was the only compound that was found to be inactive for both SHG and two-photon fluorescence, visualized by using laser transmittance alone.

### Quantitative Capabilities

The AF-PTIR results were used to obtain quantitative estimates of the sensitivity and the limit of detection of the method. The volume fraction of AF-PTIR active particles within a field of view (FoV) assuming spherical particles was found to be ˜25%. Following the method of Smith et al 0.42 for auto-calibration in image analysis, the value of integrated AF-PTIR intensity per unit volume was 190 counts/μm3. Based on the noise floor level measured in the absence of QCL modulation, we estimate that the smallest particle that can be detected using AF-PTIR with SNR 3 corresponds to a limit of detection of 0.16 μm3, or 5 parts per million. This LoD corresponds to detection of a single particle of 0.67 μm diameter in a 200 200 μm2 FoV.

The absolute sensitivity of AF-PTIR measurements was assessed by estimation of the total photon count. An average integrated voltage over a 100 ns window for our instrument was 0.327 m V/photon. During the measurement, the measured voltage over the same 100 ns window was 15.65 mV, which corresponds to roughly 48 photons per 100 ns or 4.8 108 photons per second. Based on Poisson statistics, a modulation depth of 1% is expected to enable measurements with the SNR around 40 for a 30 ms pixel dwell time [1.4 105 photons/1.4 107 photons]. In practice, the observed SNR exceeded this Poisson metric at several locations, suggesting modulation depths of several percent during the acquisition.

### AF PTIR Mapping of the Drug Distribution and Identification of Excipients With Multimodal Nonlinear Optical Microscopy

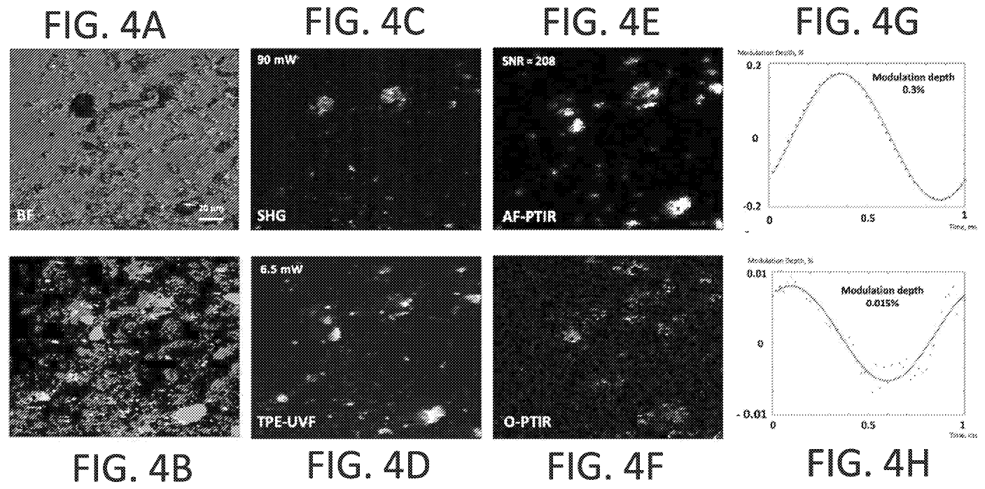

A physical mixture of four representative components was prepared to test the capabilities and limitations of nonlinear optical microscopy for pharmaceutical substances imaging and analysis. The results of bright field, SHG and TPE-UVF measurements are demonstrated in FIGS. 4a, 4c, and 4d. As expected for multimodal imaging, contrast for different species varied qualitatively across the different measurement suites.

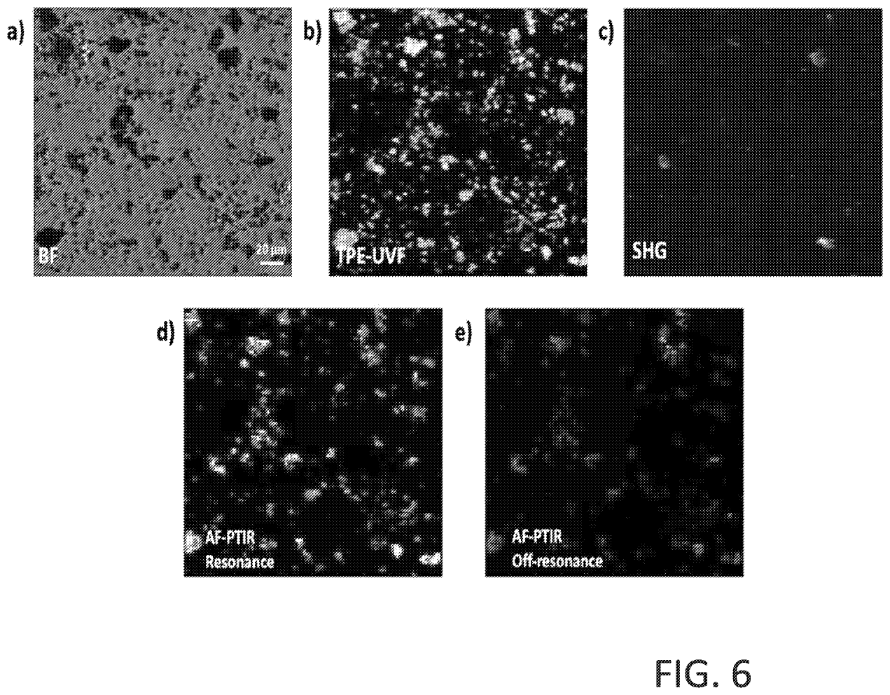

AF-PTIR microscopy was applied to perform vibrational analysis of the TPE-UVF active domains, which potentially include both indomethacin and titanium dioxide. The image in FIG. 4e was produced while serially activating 5 QCL channels that correspond to the strongest mid-IR absorption of indomethacin based on its IR spectrum (1069, 1081, 1085, 1089 and 1149 cm−1) and absence of significant titania absorption at those same wavelengths (FIG. 6a). Analogous measurements acquired with IR channels that exhibit weak indomethacin absorption (1054, 1058, 1158, 1162 and 1167 cm−1) yielded notable reductions in AF-PTIR response. The high spectral sensitivity of AF-PTIR to wavelengths corresponding to peaks in indomethacin absorption support assignment of the particles in FIG. 4 to indomethacin.

For comparison with AF-PTIR, conventional O-PTIR microscopy measurements based on absorption-induced perturbation to visible light scattering was performed, the results of which are summarized in FIG. 4f. As in AF-PTIR, the O-PTIR image was acquired with the QCL was tuned to match the indomethacin absorption maxima, shown in FIG. 4f. Additionally, O-PTIR images collected while operating QCL sequences optimized for lactose and Mg stearate absorption are provided in the Supporting Information. The modulation depth was calculated for the brightest pixel in each of the AF-PTIR and O-PTIR images. (FIG. 4 g and h). While in principle, O-PTIR has the advantage of not requiring UV fluorescence, the selectivity to indomethacin and signal to noise are reduced relative to AF-PTIR. However, it should be noted that the O-PTIR measurements were performed using home-built instrumentation; fully optimized commercial instrumentation may yield improvements in SNR relative to that shown in FIG. 4f. Nevertheless, these trends are consistent with enhancements in SNR for F-PTIR relative to O-PTIR that are expected. Based on the fitting uncertainties for the recovered modulation amplitudes in FIG. 4g and h, fluorescence-based photothermal microscopy resulted in a 7.8-fold for the depth of modulation.

Collectively, TPE-UVF and SHG imaging of the mixture supported by AF-PTIR microscopy can be applied to map the distribution of individual components within a field of view. The threshold-based segmentation process for particle identification using bright field images is shown in FIG. 4a. A segmented and classified image is demonstrated in FIG. 4b, in which each individual component is shown in a different color. Most of the smaller particles found within the studied FoV did not produce detectable TPE-UVF or SHG, and were classified as Mg stearate particles. Small particles producing signals below the limits of detection for SHG or TPE-UVF will by default classify as magnesium stearate and may be represented differently in the detected light. Limits of detection for both methods are estimated be on the order of parts per million, corresponding to detection of single ˜1-5 m crystals in ˜2 mm by 2 mm fields of view0. 43 Particles that were bright for SHG but inactive for TPE-UVF measurements were classified as lactose monohydrate. Titania and indomethacin are both TPE-UVF active based on the results shown in FIG. 3. However, AF-PTIR microscopy enabled assignment of the TPE-UVF particles to the indomethacin crystals based on the differences in IR absorption between the two particle classes shown in FIG. 5.

The integration of AF-PTIR with multimodal imaging improves confidence in chemical classification for analysis of powdered mixtures. As demonstrated for pure constituents' powders in FIG. 3, titania microparticles can produce clearly detectable TPE-UVF signals, such that the presence of TPEUVF alone cannot unambiguously be used to assign indomethacin particles. The indomethacin sample used was comprised of the centrosymmetric-form (space group 1), with the relatively weak signal on the SHG channel tentatively attributed to break-through of visible-wavelength two photon excited fluorescence. While the-form of indomethacin is noncentrosymmetric and can support bulk-allowed coherent SHG, powder X-ray diffraction measurements confirmed the dominance of the-polymorph. Furthermore, changes in the filter set for optimization of two-photon excited fluorescence with 1064 nm excitation yielded contrast similar to that detected on the SHG channel. The spurious apparent SHG signals from indomethacin have the potential to complicate definitive assignment of lactose microcrystals. Both ambiguities from TPEUVF and SHG as stand-alone methods were effectively addressed through IR absorption spectroscopy of individual microparticles by AF-PTIR.

Complementary measurements on a commercial indomethacin final dosage form suggest that the capsule contents were comprised of isolated particles of a size distribution similar to that of our model preparation, with both SHG and TPE-UVF observed from the sample (FIG. 6). AFPTIR measurements of the TPE-UVF active particles were spectroscopically consistent with those recorded for pure indomethacin, and were assigned as such. The commercial capsule had a significantly higher volume fraction of indomethacin compared to the mixture shown in FIG. 4.

Some materials are more suitable to AF-PTIR than others. Within pharmaceutical applications, many compounds exhibiting sufficient TPE-UVF to support fluorescence-based analysis as a complement to O-PTIR. However, it should be understood that any compound having a sufficiently high TPE-UVF response by unit volume may be a good candidate for characterization in this way. From our survey of pharmaceutical materials, nearly half of small molecule APIs produce detectable TPE-UVF and could potentially contribute to an AF-PTIR response. This figure was arrived at by using ritonavir as a benchmark for which TPE-UVF measurements that are observable, and finding that about 50% of the APIs exhibit TPE-UVF activity potentially bright enough to support AF-PTIR.

In contrast, excipients or inactive materials typically do not produce a significant TPE-UVF response. As such, TPE-UVF imaging can be a useful way to distinguish many active from inactive ingredients. In our survey, HPMC was the only excipient producing substantial TPE-UVF activity. Species exhibiting relatively weak TPE-UVF responses may require significantly longer integration times for comparable signal to noise in detection.

AF-PTIR microscopy suggests several practical advantages complementing stand-alone measurements by O-PTIR imaging. Firstly, due to the significantly higher temperature-induced variations, fluorescence intensity is a more sensitive signal reporter compared to refractive index change, consistent with the increased signal-to-noise in the AF-PTIR images. Furthermore, AF-PTIR enables selective vibrational spectroscopy with higher intrinsic selectivity to the API-rich regions of primary interest when characterizing drug distributions within dosage forms. In the studied case, API particles were mixed at a relatively small volume fraction, but imaged with negligible interference from TPE-UVF inactive excipients by AF-PTIR. O-PTIR produced broad applicability across all analytes, but with lower sensitivity to indomethacin. For the mixture discussed here, lactose and indomethacin exhibited higher absorption cross sections relative to other components in the mixture, which resulted in significant cross-talk in demultiplexed O-PTIR images designed to optimally discriminate based on mid-IR absorption at the accessible QCL wavelength channels (details are provided in the Supporting Information).

AF-PTIR imaging complements targeted spectroscopy of locations adjacent to site-specific fluorescence labels in FPTIR. In prior studies with F-PTIR, fluorescence labeling enabled highly localized chemical characterization of cell organelles and single bacteria, supporting measurements of the composition of regions adjacent to selective structures of interest. The present studies by AF-PTIR provide complementary label-free analysis adjacent to aromatic moieties that can, in principle, be acquired concurrently with targeted F-PTIR (e.g., through simultaneous one and two photon excited fluorescence). Pairing of multiple complementary imaging modalities such as AF-PTIR, F-PTIR, OPTIR, with independent contrast methods such as SHG can significantly improve the classification confidence, as demonstrated in FIG. 4.

Given that the infrared excitation is within the same molecule as the electronic transition driving fluorescence, it is worthwhile to consider contributions to the AF-PTIR signal from coherent intramolecular interactions, such as resonance-enhanced three photon excitation (IR+vis+vis). The peak power of the mid-IR QCL source was ˜10-9 of the peak power of the excitation beam, when accounting for the significantly lower power and ˜15 times larger focal spot-size of the former. As such, for every 1 IR photon overlapping with a given visible pulse, 109 mid-IR photons not spatially or temporally coincident were contributing to the AF-PTIR response. Given both the low spatiotemporal overlap combined with the overall inefficiency of three-photon absorption compared to two-photon excitation, three-photon processes were assumed to contribute negligibly to the detected AF-PTIR signal.

It should be noted that because AF-PTIR relies on fluorescence emission as the signal generation source, effects such as self-quenching in crystals might potentially impact the total fluorescence signal. As was demonstrated previously, self-quenching could influence the relative autofluorescence brightness of molecular crystals different polymorphs. Auto-quenching generally competes with fluorescence, such that transient temperature changes may significantly affect the balance between fluorescence and autoquenching. The total AF-PTIR signal scales with the combined product of the quantum efficiency and the derivative of the QE with temperature. As such, it is not immediately obvious how self-quenching will impact the sensitivity of AF-PTIR (decreases in QE may be offset by increases in dQE/dT). Additional AF-PTIR studies performed on different polymorphic forms of otherwise identical crystals may help disentangle these competing effects. In any case, autoquenching can be reasonably expected to be independent of the IR wavelength responsible local absorption and heating, such that classification based on AF-PTIR vibrational spectral analysis should not be substantially affected by overall differences in absolute quantum efficiency.

The ubiquity of TPE-UVF active aromatic groups natively present within many samples of interest suggest broad applicability of AF-PTIR in studies of biologically relevant materials. The present study suggests utility for label-free analysis of many pharmaceutical materials with high selectivity for the API, complementing previous O-PTIR measurements by Li et al. The extensive use of TPE-UVF for native protein imaging, suggests applications for studying lyophilized and crystalline protein particles and tissue sections. Multiphoton excited autofluorescence of NADH is commonly used to probe local cell metabolism and could provide yet another complementary local label-free probe for AF-PTIR analysis.

Autofluorescence-detected photothermal mid-IR (AFPTIR) microscopy can be used as a label-free technique and applied to map the spatial distribution of materials in a mixture containing non-active ingredients such as pharmaceutical excipients. AF-PTIR microscopy provides an additional level of selectivity for nonlinear optical imaging of pharmaceutical final dosage forms through mid-IR spectroscopy with high spatial resolution. When combined with bright field, SHG and TPE-UVF imaging, AF-PTIR enabled segmentation of the field-of-view to visualize each of the individual mixture components. AF-PTIR achieved improved chemical selectivity and signal to noise characteristics when compared to optically-detected photothermal microscopy for pharmaceutical materials analysis. AF-PTIR has the potential to aid in assessing content uniformity in pharmaceutical tablets production by rapidly visualizing the spatial distribution of active pharmaceutical ingredients within final dosage forms.

Two-photon excitation supports label-free F-PTIR microscopy in other materials, as well. For example, most proteins exhibit native UV-fluorescence activity excitable by two-photon absorption with −100 fs pulses of 532 nm light due to the content of aromatic amino acids residues, mainly tryptophan with an emission peak centered around 350 nm. TPE-UVF is also natively observed in many small molecule active pharmaceutical ingredients.

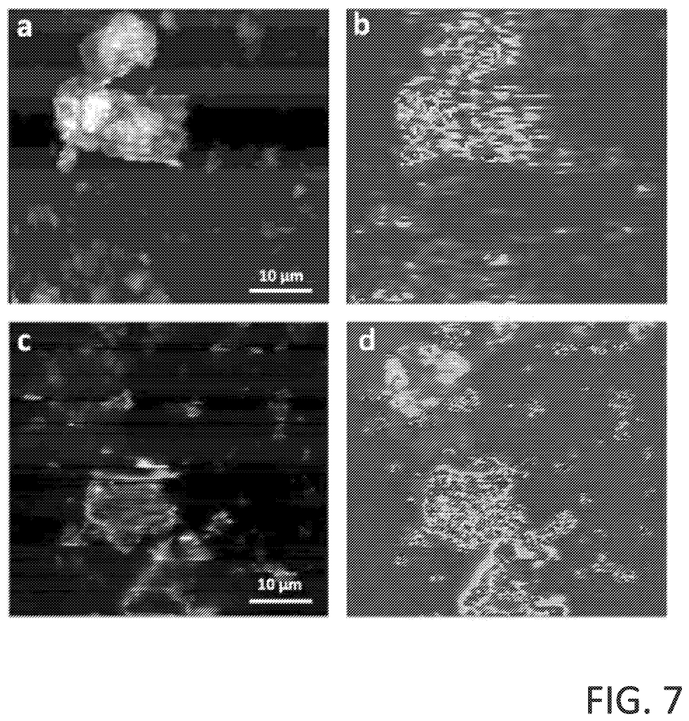

Autofluorescence of proteins can also be excited by nonlinear two-photon absorption when using ultrafast excitation visible source. Proof-of-concepts measurements of label-free fluorescence-detected mid-infrared photothermal microscopy in the UV-region (UVF-PTIR) are shown in FIG. 7. In FIG. 7 panels A and B, epi-fluorescence field-of-view and corresponding UVF-PTIR images of tryptophan microcrystals are provided. In FIG. 7 panels C and D, epi-fluorescence field-of-view and corresponding UVF-PTIR images of lysozyme particles are provided.

Measurements that made the images of FIG. 7 were obtained using an ultrafast Nd-YAG laser source (NKT Photonics Fianium FemtoPower I 060) frequency-doubled to 532 nm. Initial measurements performed using pure tryptophan microcrystalline powder (Sigma, 98%) showed good agreement between the recovered UVFPTIR and FTIR spectra (FIG. 5D in the main manuscript). Building on these results, images of lyophilized lysozyme particles (Sigma, lysozyme from chicken egg white) shown in FIG. 7 panels C and D, demonstrate high UVF-PTIR contrast for protein-rich locations.

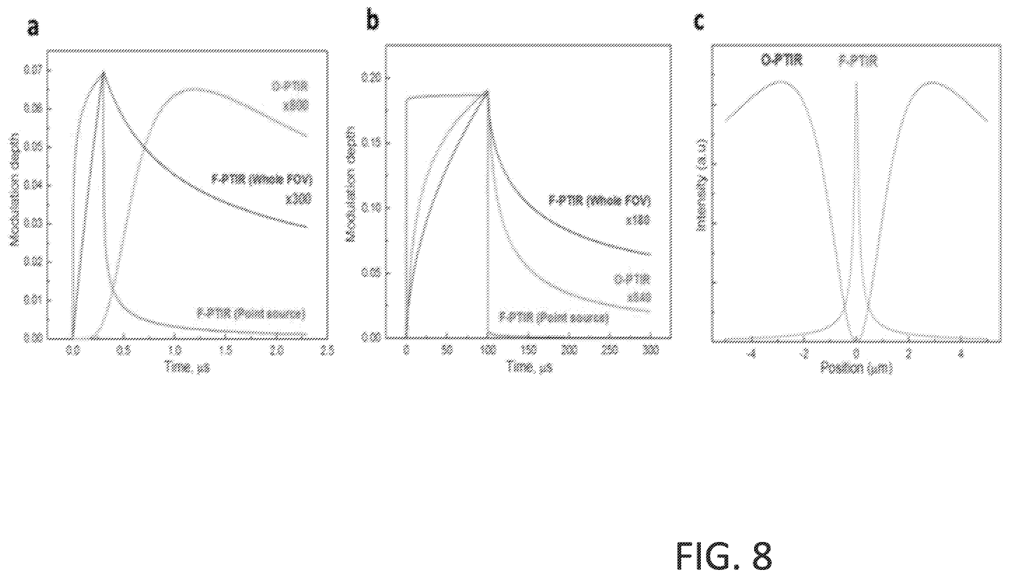

FIG. 8 shows a theoretical model on which the systems described herein behave. In FIG. 8, simulated F-PTIR and O-PTIR time-dependent depth of modulation curves for 150 nm point source infrared absorption are shown. Panel a shows a 300 ns excitation pulse, indicating the differences expected for co-localized fluorescence, fluorescence from a uniform bath, and the O-PTIR response. Panel b shows analogous predictions for 100 s infrared excitation. Panel c shows the axial point-spread functions of F-PTIR and dark-field O-PTIR after 300 ns IR excitation (although two lobes are shown for O-PTIR, typical dark field measurements will access only one).

The point spread function (PSF) for photothermal microscopy exhibits a node of zero amplitude for a point source centered within the probe beam focal plane and is markedly different from a conventional Gaussian beam PSF expected for F-PTIR. Furthermore, the maximum in the PSF for O-PTIR is axially offset from the focal plane of the probe beam, such that brightfield/fluorescence and O-PTIR signals generally do not probe the same sample plane. In a dark-field O-PTIR configurations based on detection of beam deflection, only one of the two lobes shown in FIG. 8, pane c will generally be experimentally accessible, leading to large axial asymmetry in the PSF not present in F-PTIR.

The much larger predicted axial extent of the PSF in O-PTIR relative to F-PTIR is a consequence of diffuse infrared excitation from the longer assumed wavelength (˜10 μm in the simulation shown in FIG. 8) together with increases in beam deflection from geometric optics as the thermal lens is displaced away from the focal volume. Finally, dark field configurations commonly used in O-PTIR inherently exhibit higher detected light flux from locations of scatter/refraction, including interfaces within the sample. If the O-PTIR signals is not rescaled by the average detected intensity measured at that location, the higher flux in dark-field O-PTIR can increase the amplitude of modulation proportionally. The corresponding increase in O-PTIR modulation amplitude arising from scattering in dark-field geometries has the potential to bias the interpretation of image contrast if attributed to IR absorption alone. The interplay between scattering within the probe beam focal plane and O-PTIR within an offset focal plane may produce nontrivial image contrast in dark-field O-PTIR microscopy. Such sources of bias from scattering were not incorporated in the O-PTIR simulations shown in FIG. 8.

Simulations of the time-dependent and position-dependent O-PTIR response are shown in FIG. 8. The O-PTIR response was assumed to be proportional to the change in beam position at the maximum numerical aperture of the objective, representing an upper bound for the sensitivity of a dark-field measurement configuration. The temperature change used to calculate the effective focal length was evaluated by considering the temperature at an offset of Wo relative to the point source center position and setting An equal to the maximum of a corresponding Gaussian temperature distribution centered on the point source for compatibility with the Gaussian beam propagation expressions. Since the O-PTIR signal is zero for a point source positioned at the focal point of the probe beam, the point source was assumed to be axially offset by a displacement of \sqrt{3} Z₀, which yields the theoretical maximum sensitivity.

From the simulations, the O-PTIR response exhibits several interesting trends relative to F-PTIR. First, as expected, simulations of the O-PTIR response as a function of axial position in FIG. 8, panel c, indicate a node in the signal for a photothermal point source positioned in the focal plane of the probe beam, with maximum sensitivity offset by displacements of either ±˜\sqrt{3} Z₀ (typical dark-field configurations will exhibit sensitivity to either positive or negative displacement, but not both). These predictions are consistent with past experimental measurements and modeling of photothermal microscopy of isolated nanoparticles.

In contrast, the F-PTIR sensitivity is expected to scale directly with the intensity distribution within the excitation beam (also shown in FIG. 8, panel c, for reference). Assuming a probe beam offset of \sqrt{3} Z₀, the time-dependent evolution of the O-PTIR response maps closely that of the F-PTIR signal expected for fluorescence from an isotropic bath. In retrospect, this result is consistent with both O-PTIR and non-localized F-PTIR producing signals scaling with the net temperature change across the entire focal volume, while localized F-PTIR produces much faster response times following excitation and cessation. Finally, the maximum relative change in the O-PTIR response is several orders of magnitude smaller than either model for F-PTIR, consistent with the small expected change in refractive index with temperature compared to that of fluorescence.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A method for analyzing a sample, the method comprising:
illuminating a region of the sample with an infrared radiation beam;
illuminating at least a sub-region of the region of the sample with a pulsed excitation beam having a shorter wavelength than the infrared radiation beam wherein the excitation beam is configured to excite multi-photon autofluoresence in the sample;
collecting an autofluorescent emission from the sample in response to absorption of the pulsed excitation beam by the sample;
detecting a change in the autofluorescent emission from the sample in response to absorption of infrared radiation by the sample; and
generating measurements indicative of infrared absorption of the sub-region of the sample from the change in autofluorescent emission from the sample.

2. The method of claim 1, further comprising the step of producing a spectrum of infrared absorption of the sample.

3. The method of claim 1, wherein the infrared radiation beam is generated by an IR source comprising at least one quantum cascade laser.

4. The method of claim 1, wherein the infrared radiation beam is generated by an array of quantum cascade lasers.

5. The method of claim 1, wherein the pulsed excitation beam is generated by an ultrafast light source.

6. The method of claim 5, wherein ultrafast light source generates excitation pulses having a pulse duration of less than 200 femtoseconds.

7. The method of claim 5, wherein the ultrafast light source generates excitation pulses with a pulse duration of less than 10 nanoseconds.

8. The method of claim 5, wherein the ultrafast light source emits visible radiation.

9. The method of claim 1, further comprising constructing a spatially resolved image indicative of absorption of infrared radiation by the sample.

10. The method of claim 9, further comprising constructing an image of symmetry-specific second harmonic generation.

11. The method of claim 1, further comprising classifying individual particles within a pharmaceutical mixture.

12. The method of claim 11, wherein classifying individual particles comprises distinguishing excipient materials from active pharmaceutical ingredients.

13. The method of claim 11, wherein classifying individual particles comprises distinguishing between different forms or polymophs of active pharmaceutical ingredients.

14. The method of claim 12, wherein the sample is a pharmaceutical formulation.

15. The method of claim 1, wherein collecting the autofluorescent emission comprises detecting the autofluorescent emission from the sample at a detector comprising at least one of: a photomultiplier tube and an avalanche photodiode.

16. A photothermal infrared spectroscopy system comprising:
an infrared source configured to illuminate a region of a sample with a beam of infrared radiation;
an ultrafast light source configured illuminate a second region of the sample at least partially overlapping the infrared illuminated region, wherein the ultrafast light source is configured to excite multi-photon autofluorescence in the sample;
at least one detector configured to detect autofluorescent emission from the sample; and
a demodulator to detect a change in autofluorescent emission from the second region of the sample in response to absorption of infrared radiation by the second region of the sample.

17. The photothermal infrared spectroscopy system of claim 16, further comprising a controller configured to produce measurements indicative of infrared absorption of the second region of the sample.

18. The photothermal infrared spectroscopy system of claim 16 wherein the ultrafast light source comprises a laser and a doubling crystal.

19. The photothermal infrared spectroscopy system of claim 16 wherein the second focusing optic is an objective having a numerical aperture of at least 0.60.

20. The photothermal infrared spectroscopy system of claim 16, wherein the detector comprises a photomultiplier tube.

21. The photothermal infrared spectroscopy system of claim 16, wherein the detector comprises an avalanche photodiode.
